(19) United States
(12) Patent Application Publication
(10) Pub. No.: US 2005/0270297 A1
(43) Pub. Date: Dec. 8, 2005

(54) Time sliced architecture for graphics display system

(75) Inventors: Tarjinder Singh Munday, Ludhiana (IN); Shirish Gadre, Fremont, CA (US); Jean Swey Kao, Cupertino, CA (US); Edward J. Paluch, Santa Clara, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignee: SONY CORPORATION and SONY ELECTRONICS INC.

(21) Appl. No.: 10/864,914

(22) Filed: Jun. 8, 2004

(51) Int. Cl. G06F 15/16; G06T 1/20; G06F 15/80; G06F 15/167

(52) U.S. Cl. 345/502; 345/505; 345/506

(57) ABSTRACT

A system and method for rendering multiple windows across multiple display planes utilizing a sliced rendering data pathway architecture for achieving a highly area efficient design of the graphics display system. Windows across multiple display planes are rendered from direct memory access fetch engines retrieving pixel data from memory. Rendering data pathways are shared between direct memory access fetch engines directed to a single display plane. Furthermore, the rendering data pathways can be time sliced wherein data from multiple planes are time multiplexed through the rendering pathway. The invention allows creating a graphical engine with a lower gate count than conventional circuits. The resultant system is modular and scalable, while being customizable from lower power applications to HDTV sets.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to a system and method for processing graphics data, and more particularly to an integrated circuit graphics display system.

2. Description of Related Art

A graphics system typically contains a graphics controller card having a graphics controller chip that can process both graphics data and video data to produce graphics and video pixel data. The graphics controller generally contains a graphics processing engine that processes graphics data to produce pixel data, and a graphics display engine that routes graphics pixel data to a display device. In multimedia systems, some graphics controllers may also have video display engines that process and route video pixel data to the display device. Graphics and video data must be processed differently because each type of data is formatted differently.

Every multimedia processor requires a graphics display engine to render a variety of graphics windows, each having pixel data in a variety of formats. A number of alternative data formats may be utilized, such as indexed, 16 bit, 24 bit, 32 bit, RGB, YCbCr, 4:2:2, and so forth. Typically, the graphics system will route the various windows to the display device, wherein the pixel data is displayed in planes in the display device. A typical system application may require many such windows in the same plane, these windows may possibly be even horizontally overlapping windows. To maintain a high quality and intuitive user interface the graphics display system may require multiple application planes.

FIG. 1 is a prior art illustration of a windows rendering system that renders multiple windows to the same applications plane. Graphics windows are typically characterized by window descriptors. Window descriptors are data structures that describe one or more parameters of the graphics window. Window descriptors may include, for example, image pixel format, pixel color type, location on screen and so forth. In addition, each window may have its own alpha blend factor, location on the display screen or other parameters. In addition to each window having its own alpha blend factor, each pixel may have its own alpha value. As shown in the figure, the graphics system 100 comprises a variety of windows engines 130-136 which couple to each of application planes 120-123, that are coupled to a memory 110 in graphics system 100. In the system shown in the figure, each windows engine 130-136 has corresponding Direct Memory Access (DMA) fetch engines (DFE) 140-146 and data paths (DP) 150-156 for rendering graphics images to corresponding applications planes. Each of the windows rendered to the applications planes has graphics pixel data.

FIG. 2 illustrates partitioning the graphics pixel data into the different applications planes (e.g., plane 1-plane 5). In the illustration, each of the planes has application windows which may range from overlapping windows in plane 120, to vertically disjointed windows in plane 121, or four overlapping windows in plane 123, and the like. Typically, in order to have a meaningful contiguous display for a particular pixel data, the applications windows have to be blended together for the final display. Typically, the applications windows are programmed into system memory 110 as linked list structures of headers having address pointers to the associated pixel data. In certain situations, the display format may be different from the source format and therefore the graphics display system may have to support format conversion, color expansion, interpolation (for 422 to 444 conversion), table look up (for indexed modes) and other similar features. In the example shown in FIG. 2, consider that P represents the number of application planes that the display system may need to support, and W represents the maximum number of windows per plane which are active in a scan line. In this case the display system would require W multiplied by P window engines to support this number of windows. These demanding requirements translate into a requirement for a large silicon area for the underlying graphics chip, an area proportional to W multiplied by P.

Functionally, a windows engine can be partitioned into a Direct Memory Access (DMA) fetch engine (e.g., DFE 140) and a rendering data path (e.g., DP 150). A DMA fetch engine typically consists of data buffering, barrel shifters and window coordinate comparators, and so forth. The rendering data path typically consists of pixel operations such as indexed look up table, color conversion, color expansion, and the like. Each of the components in the underlying rendering data path and the DMA fetch engines require corresponding electrical circuits (e.g., gates) for the fabrication of the graphics chip. In a conventional graphics system for displaying multiple types of graphics and pixel data, the electrical circuitry required to fabricate these components is expensive, bulky and consumes substantial power.

For example, in the graphics system shown in FIG. 1, if CW is the cost of the DMA fetch engine (DFE), CP is the cost of the rendering data path (DP), since there are W×P window engines for each displayed window, the total cost of the graphics display system design would be equal to (W×P×(CW+CP)). Additionally, there would be the cost of blending the various planes together. The cost of rendering data paths is usually large due to the number of lookup tables, multipliers, adders, and so forth. The additional components must each be placed on the limited surface area of the graphics chip and contribute to heat generation while adding to the delay of data processed by the graphics chip.

Accordingly, a need exists for a graphics system and method for processing multiple graphics data which avoids these and other problems of known systems and methods. The present invention solves these problems to provide lower overhead graphics processing and overcoming a number of deficiencies in the prior graphic systems.

### BRIEF SUMMARY OF THE INVENTION

The data processing apparatus of the present invention provides optimization and resource sharing strategies for a graphics display system. One aspect of the invention is the reuse of the rendering data path for all windows of a plane to reduce the number of data paths. Another aspect of the invention is a modular and scalable time sliced approach to achieve a highly area efficient design of a graphics display system while providing a high quality user interface for multiple application planes with multiple applications windows on a normal silicon chip with low power requirements. The present invention therefore provides a system and method of reducing the number of component circuitry that may be required to design a multimedia graphics chip to support multiple applications that require multiple window engines for generating multiple applications windows.

In one embodiment, an apparatus for rendering multiple graphic windows according to the present invention comprises (a) a plurality of application planes configured for maintaining application windows; and (b) means for rendering the output of the application planes to the application windows over graphic rendering data paths being shared for a given application plane.

In one embodiment, the means for rendering comprises a graphics display engine coupled to the application planes and means for sharing rendering data paths for a given application plane. In one embodiment, the graphics display engine comprises (a) a window engine configured for generating an application window; (b) a direct memory access fetch engine coupled to the window engine, and configured for rendering a graphic image of the application window; and (c) a data path coupled between the direct memory access fetch engine to an application plane upon which the graphic image of the application window is to be rendered.

The invention may also be implemented as an integrated graphics display chip. In one embodiment, the display chip comprises (a) a plurality of applications planes; (b) a memory configured for retaining graphics data including pixel data; (c) a plurality of window engines for rendering a plurality of graphics windows; (d) a plurality of direct memory access fetch engines coupled to the plurality of window engines, and configured for fetching windows information from the memory; (e) a rendering data path coupled to the plurality of direct memory access fetch engines and configured for outputting pixel data corresponding to the plurality of graphics windows to each of the plurality of application planes; and (f) a display blender for blending the plurality of applications planes into a single plane to be displayed by a display device at any given time.

In a further embodiment, a method of rendering a plurality of application windows according to the invention comprises (a) rendering application windows across multiple planes as pixel data is retrieved in a windows formation fetch operation from memory; (b) sharing a rendering data pathway for processing pixel data rendered across different application windows; and (c) blending the pixel data received from multiple planes from said rendering data path for output to a display.

The rendering data pathway is configured for processing pixel data rendered across different application windows for a given plane, and may be further utilized by performing time division multiplexing of the data pathway to time slice the use of said data pathway to increase throughput of pixel data.

Accordingly, a beneficial aspect of the invention is to provide a first level of optimization for reducing the number of window rendering data paths when rendering multiple windows to the same plane by reusing a graphics rendering data path for all windows rendered to the same plane to reduce the silicon area.

Another aspect of the invention is to provide a time sliced rendering data path by taking advantage of the underlying small gate delays of a multimedia chip with a deep sub micron process technology to operate the consolidated data path at frequencies higher than the required throughput of the gates.

A further aspect of the invention is to provide a graphics display engine that dynamically allocates Direct Memory Access (DMA) engines to application software to ease the constraints on software.

A still further aspect of the invention provides a method of blending multiple applications windows from different planes by using a multiply accumulating approach to reduce the cost of a multiply accumulate (MAC) than a parallel multipliers and adders approach.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a conventional graphics display system.

FIG. 2 is a perspective view of a conventional multiple applications plane with multiple windows displayed in each plane.

FIG. 3 is a block diagram of an integrated circuit graphics display system according to an embodiment of the present invention.

FIG. 4 is a block diagram of aspects of the present invention, showing certain functional blocks of the graphics system.

FIG. 5 is a block diagram of an exemplary multiple windows generation data flow for one embodiment of the present invention.

FIG. 6 is a perspective view of an exemplary application plane with multiple overlapping windows according to one embodiment of the present invention.

FIG. 7 is a block diagram of one embodiment of a switch fabric architecture according to an embodiment of the present invention.

FIG. 8 is a timing diagram of signals that may be used in time slicing plane through a rendering data path according to one embodiment of the present invention.

FIG. 9 is a timing diagram of signals that may be used to program applications plane reordering through a rendering data path of the present invention.

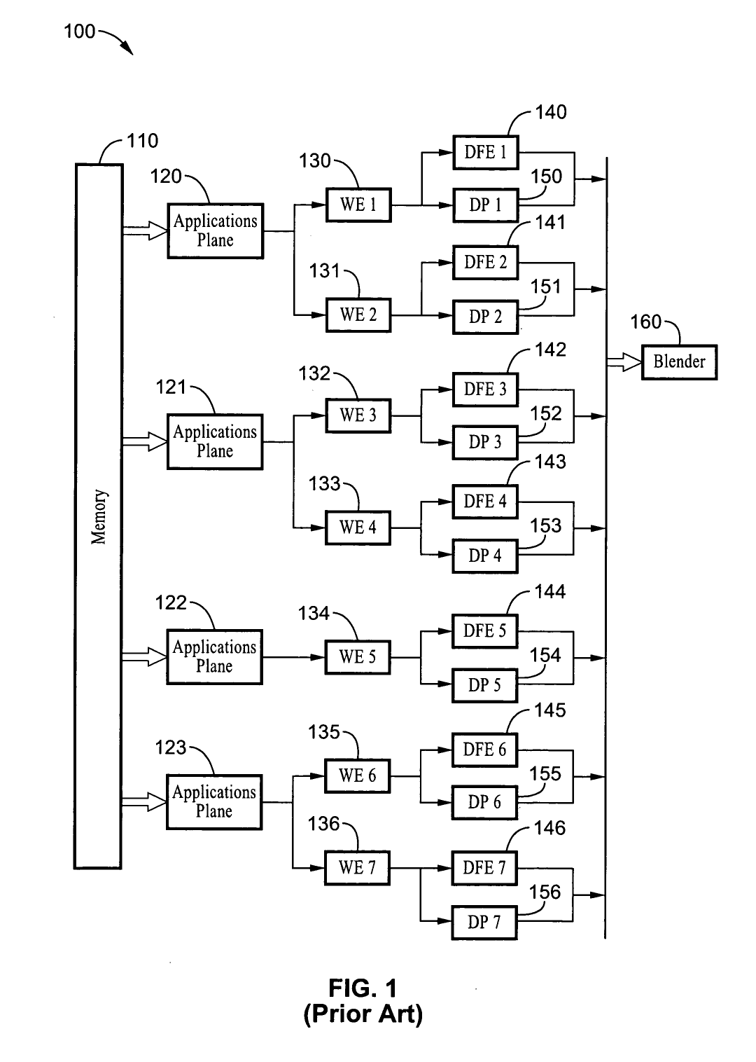

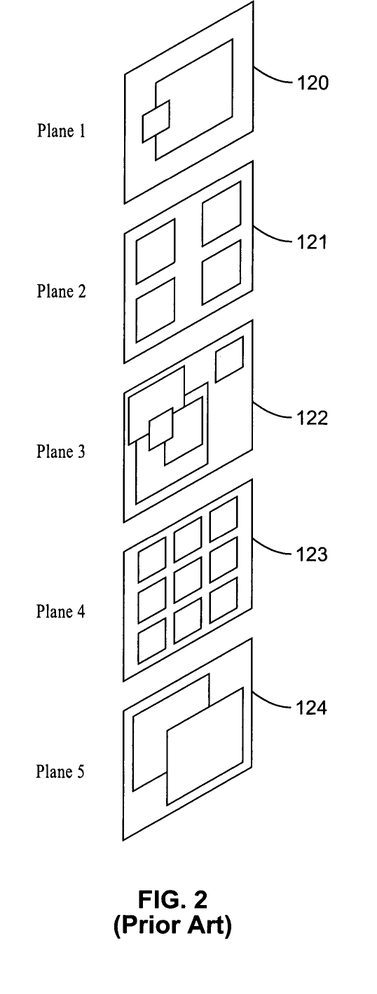

### DETAILED DESCRIPTION OF THE INVENTION

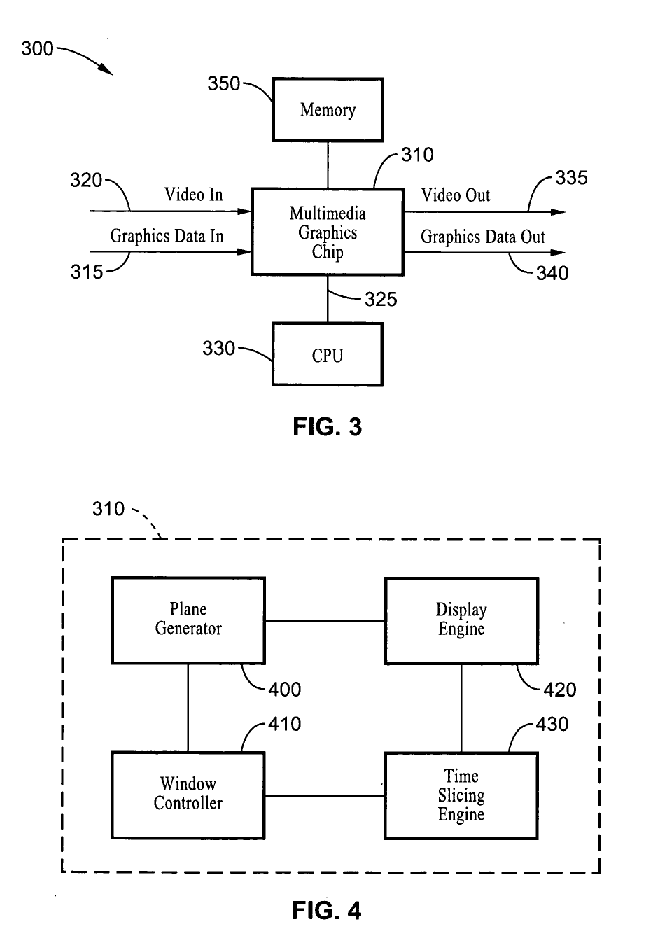

Referring more specifically to the drawings, for illustrative purposes the present invention is embodied in the apparatus generally shown in FIG. 3 through FIG. 9. It will be appreciated that the apparatus may vary as to configuration and as to details of the parts, and that the method may vary as to the specific steps and sequence, without departing from the basic concepts as disclosed herein.

The present invention provides for the reduction in the number of elements in graphics system chip component circuitry as a consequence of sharing the rendering data paths for pixel processing in a graphics display engine to the same display plane. Additional aspects of the invention provide further improvement to the sharing, by utilizing time slicing, switching fabric architecture, and other enhancements.

FIG. 3 illustrates by way of an example embodiment of a graphics display system 300 which is preferably contained on an integrated circuit 310 for receiving graphics signals 315 and video signals 320 and which provides a bus 325 for connection to a CPU 330, and output signals for video output 335 and graphic output 340. System 300 may further connect to graphics display system memory 350, which preferably comprises a unified synchronous dynamic random access memory (SDRAM) that is shared by the system, CPU 330 and other peripheral devices in system 300.

In one embodiment, graphics system 300 accepts video and graphics input signals that may include a variety of graphics or video formats and the integrated chip 310 outputs a variety of graphics windows in accordance with the teachings of the present invention to a connecting display device.

FIG. 4 illustrates an example of a graphics integrated circuit embodiment preferably comprising application plane generator 400, window controller 410, display engine 420 and time slicing engine 430. In one embodiment, the graphics display system preferably processes graphics data using logical windows, also referred to as viewports, surfaces, sprites and canvasses, that may overlap or cover one another with arbitrary spatial relationships. Each window is preferably independent of each other. The windows may consist of any combinations of image content including indexed, 16 bit, 24 bit, 32 bit, RGB, YCbCr, 4:2:2, and so forth.

In operation, window controller 410 manages both video and graphics display pipelines in graphics system 300. In one embodiment, windows controller 410 accesses window descriptors in memory 350 through a direct memory access (DMA) engine. For graphics information, window controller 410 preferably sends header information to display engine 420 at the beginning of each scan line and sends window header packets to display engine 420 as necessary for displaying a window.

In one embodiment, display engine 420 retrieves graphics information from memory and processes it for display. Display engine 420 converts the various formats of graphics data in the graphics window into YUV component format, and blends the graphics window to create blended graphics output having a composite alpha value that is based on alpha values for individual graphics windows, the alpha value, the per pixel value or both.

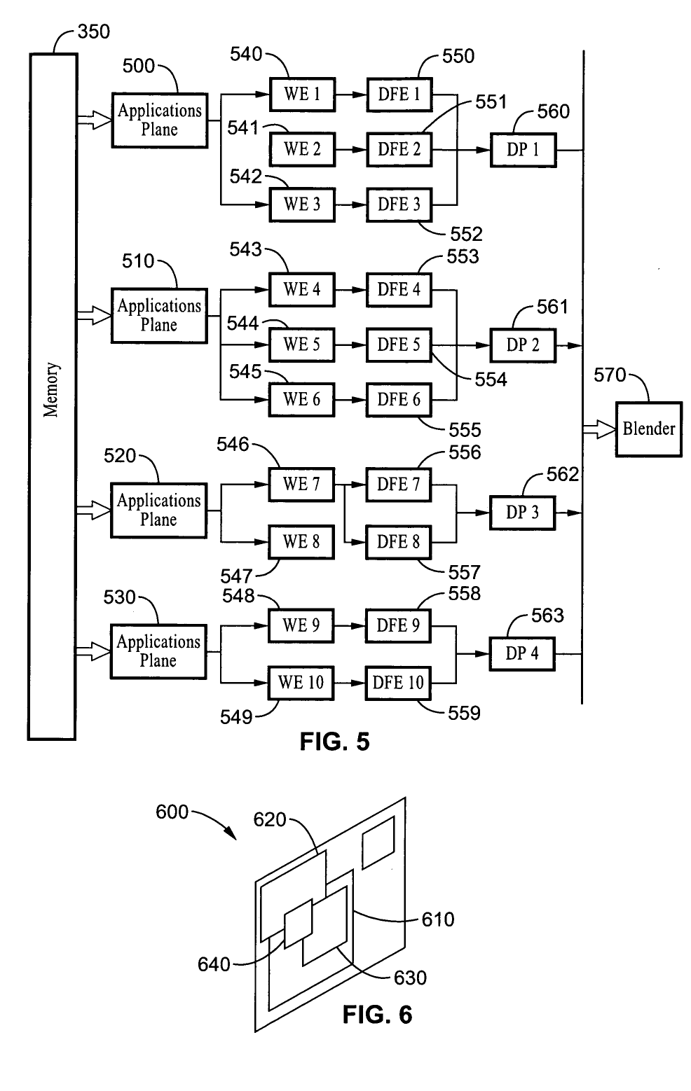

FIG. 5 illustrates a display engine according to one embodiment of the present invention, wherein the display engine comprises a memory 350 coupled to a plurality of plane generators 500-530, window engines (WE) 540-549, direct memory access fetch engines (DFE) 550-559, rendering data paths (DP) 560-563 and an alpha blender 570. In this illustrative embodiment, each plane generator has a corresponding number of window engines (e.g., applications plane 500 has window engines 540-542) to allow multiple windows to be rendered to the same applications plane. The DMA fetch engines 540-542 receive data from the windows engines as needed to construct the various graphics windows according to address information provided by the windows engine. Once a display of a window begins, the DMA fetch engines 540-542 preferably retain any parameters that may be utilized to continue retrieving the window data from system memory.

In this embodiment, each of the windows engines 540 through 549 has a corresponding DMA fetch engine 550 through 559. In order to reduce the gate count in the associated component circuitry, the integrated graphics circuit chip is fabricated for reusing the same rendering data path for the multiple DMA fetch engines to reduce the number of data paths that connect to the window engine.

Thus, instead of the conventional one-to-one correlation between windows engines and data paths or DMA fetch engines and data paths, the present invention implements a slicing architecture which enables multiple window engines with corresponding multiple DMA fetch engines 550-559 to couple to one data path. Therefore, the data paths 560 through 563 are reused by the corresponding windows engines and associated DMA fetch engines 550-559 to time slice application planes through data paths 560-563.

In one embodiment of the present invention, data paths 560-563 are decoupled from the DMA fetch engines 550-559 to allow the applications planes 500-530 to be time sliced between the data paths 560-563. In the embodiment illustrated in FIG. 5, a first level of optimization is achieved by having a rendering data path for each window (belonging to the same plane) reusing the rendering data path for all the windows of that plane. By implementing such a scheme, the number of data path required reduces to P (instead of W×P).

FIG. 6 depicts overlapping windows 600 to the same plane, wherein the output from the windows engines are resolved based on a priority scheme in which each window is assigned a priority 610, 620, 630, 640 (such as Priority 0,1, 2 and 3) and the window with the highest priority (Priority 3), 640 is displayed. In the priority window resolving embodiment of the present invention, the cost of the display engine reduces substantially to W×P×CW+P×CP; where W is the number of windows, P is the number of planes, CW is the cost of the fetch engines and CP is the cost of the data path plus the cost of the P→1 blender.

Referring back to FIG. 5, the graphics blending engine 570 receives output from data paths 560-563 and, in one embodiment, blends one window at a time along an entire width of one scan line, with the back-most graphics window processed first. The blending engine 570 uses the outputs of the data paths 560-563 to modify memory contents of SRAM 350. The result of each pixel blend operation is a pixel in SRAM 350 that consists of the weighted sum of the various graphics layers, and the appropriate alpha blend value of each layer. In one embodiment, the blending of the applications planes is performed one plane at a time on the window that is currently being composited. Once all the windows and corresponding applications planes have been blended, the current address in the SRAM 350 is freed for other applications.

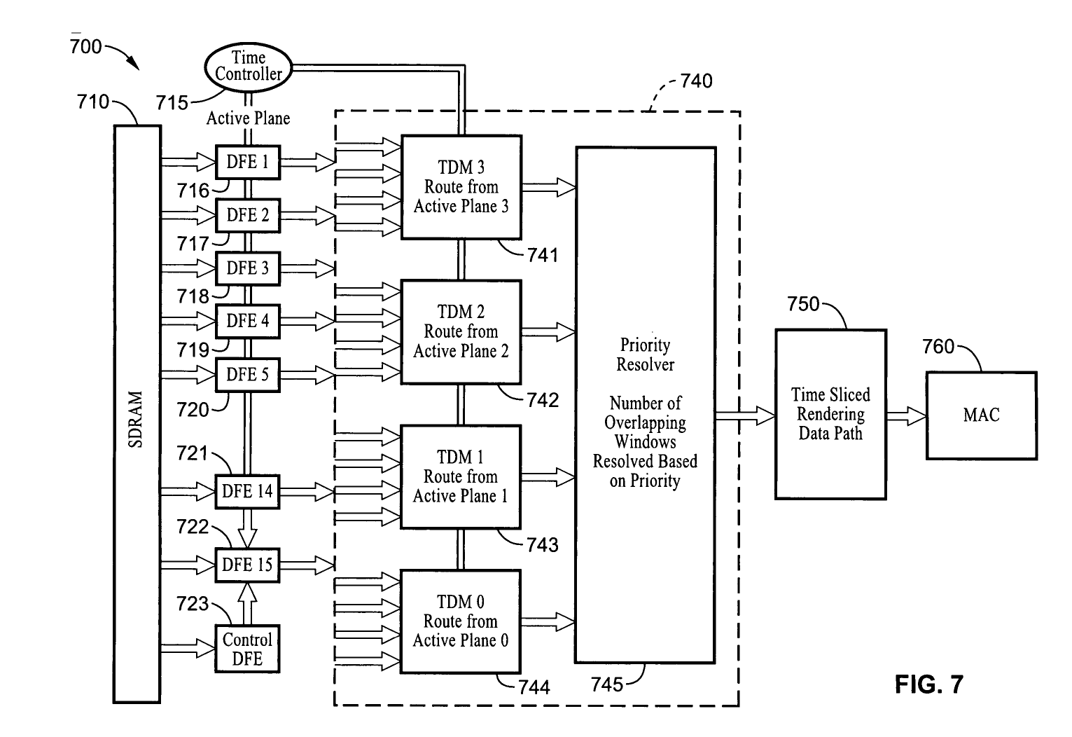

FIG. 7 is a block diagram of an embodiment 700 of the logical partitioning and data flow for a graphics display system of the present invention. As shown in the figure, the graphics system comprises system memory 710, timing controller 715, DMA fetch engines 716-722, control DMA fetch engine (DFE) 723, switching fabric 740, rendering data path engine 750 and multiply accumulate unit (MAC) 760. According to one embodiment, switching fabric 740 comprises time division (data) multiplexers (TDM) 741-744 and priority resolver 745. In one implementation time sharing of the rendering data path 750 can be achieved by splitting pixel processing into two operations: DMA fetch operations and the rendering data path operations.

The switching interconnect fabric 740 connects the outputs of the DMA fetch engines 716-722 to the rendering data path 750, in order to support a number of windows per plane during a particular scan line with a number of planes (e.g., P plane). In one embodiment of the present invention, the integrated circuit may be designed to have W×P identical DMA fetch engines 716-722 to fetch the window information and pixel data from system memory 710. However, depending on the system considerations, the actual number of DFEs 716-722 displayed may be less than (W×P). Similarly the number of overlapping windows allowed (M) in a plane may be less than W; (M≦W). In this embodiment all DMA fetch engines 716-722 are assigned unique identifiers, referred to herein as dfe_id, which are between one and N where (1≦dfe_id≦N).

Each of DFEs 716-722 can be assigned to operate on a particular window. This assignment of windows to DMA fetch engines 716-722 is preferably handled in software by designating the dfe_id in a programmable window header. The control DFE 723 receives the window header from the system memory 710, and then based on the dfe_id it programs the specific DFE with the window parameters in the window header, such as window geometry, window mode and so forth. The window DFE identifiers of the windows assigned to it is in the active region of a particular plane using the window coordinates information. In one embodiment, an output pixel in the active region is a function of the input pixel data from the window, bits per pixel, window header parameters such as window priority output device parameters, and the like, in the active region.

The DFEs 716-722 encode all of the information into a pixel command. The switching fabric 740 selects and transports one of the pixel commands per cycle to the rendering data path. The timing controller 715 selects the plane number assigned to the current data path time slot and controls the switching fabric 740. The timing controller 715 preferably issues the current active plane number to the DFEs 716-722 (in the order of plane blending). The DFEs 716-722 generate their respective encoded pixel commands only when their respective window plane number matches the active plane number. Otherwise, the DFEs 716-722 output is inactive, such as all zeros. Only up to a certain number (M) DFEs (with overlapping windows) can have an output pixel command processed by the data path 750 for the current active plane at every pixel out of the number (N) of DFE engines 716-722. However, data path 750 can process only one of these pixel commands at a time. The system resolves the display of overlapping windows by implementing a window prioritization scheme based on a priority assignment by priority resolver logic 745. Since for a given plane only up to M windows may overlap, an M→1 priority resolution may be utilized to resolve window displays in a particular plane. The switching fabric 740 comprises an N→M interconnect matrix followed by a M→1 priority resolution.

Still referring to FIG. 7, the switching fabric 740 connects the number of DFEs to the pixel data path 750. The switching fabric 740 can be configured to comprise a plurality of time division (data) multiplexers (TDMs) 741-744 in the priority resolver. The TDMs 741-744 layer has to implement M out of N selection logic to input a M→1 priority resolver. An embodiment can be implemented utilizing M(N→1) selectors. However, N tends to be large (e.g., N≦W*P). This may constrain the number of windows assignment to the DFEs 716-722. To prevent an arbitrary assignment of windows in a plane to any of DFEs 716-722, the present invention preferably implements a windows assignment scheme by assigning overlapping windows rendered to the same application plane to DFEs 716-722 with different identifiers (e.g., dfe_id modulo M). With this restriction, M TDMs 741-744 each with [N/M] inputs may be utilized in the switching fabric 740.

The TDMs 741-744 are preferably wired by the following rule: output of DFE[dfe_id] is connected to port ([dfe_id/M]) of the TDM (dfe_id modulo M). It should be noted that since the overlapping windows in a plane are assigned to the DFE engines 716-722 with different (dfe_id modulo M), the pixel commands of the overlapping windows of a plane are input to separate TDMs 741-744. Thus, when timing controller 715 issues the current active plane number to the TDMs 741-744 at any pixel, each TDM can have only one active pixel command. Therefore, for every active plane, the pixel commands of its overlapping windows will be transported to priority resolver 745, which selects the pixel command with the highest priority and passes it to the rendering data path. Thereby enabling the rendering data path 750 to receive its input in a time sliced manner.

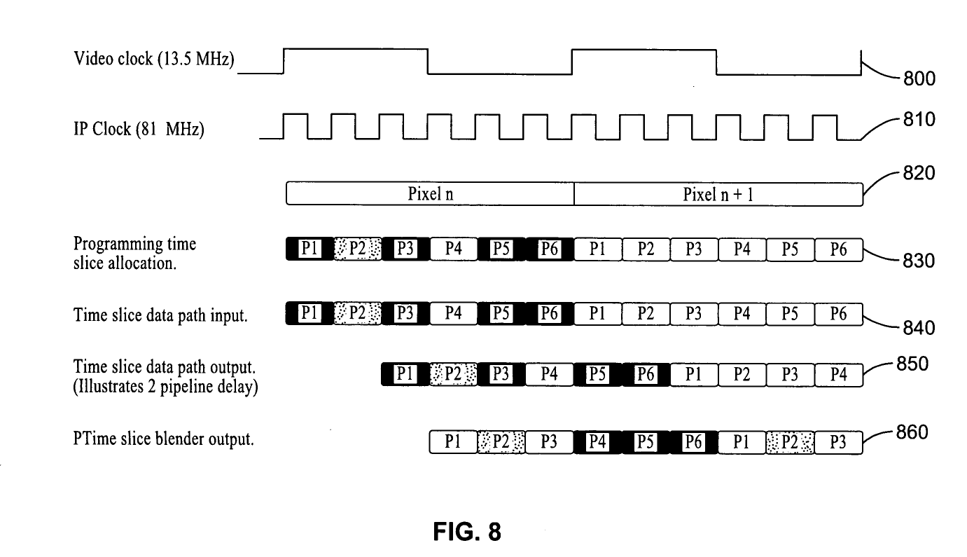

For example, in the embodiment illustrated in FIG. 7, if (N=15 and M=4), overlapping windows in a plane are assigned to selected DFEs within DFEs 716-722 when the active plane number equals that plane number, the pixel commands from the selected DFE are routed through separate data multplexers to the rendering data path 750. In this way the pixel commands for all the planes are available in the order of the plane blending as illustrated in FIG. 8.

The rendering data path 750 is preferably pipelined so that in each cycle it performs various operations based on the pixel command and outputs the plane pixel to the MAC blender 760, which blends the rendered pixels of each plane. In one implementation of the invention, the MAC blender 760 can comprise a multiply accumulate blender which has less component circuitry and therefore a lower cost than the use of conventional blenders which have multiple parallel multipliers and adders.

In an illustrative fabrication of a graphics chip incorporating the teachings of the present invention, a display device for a standard definition (SD) display with a pixel rate of 13.5 MHz and a high definition display (HD) with a pixel rate of about 75 MHz is considered. In this example design the chip is considered to be fabricated in a 0.18 micron or less process technology at an operating frequency of 167 MHz. At this frequency, the design can support up to twelve SD planes or two HD plane. The particular synthesis is achieved with the exemplary parameter settings found in Table 1.

The total gate cost of the design then comes out to be approximately 102.2K gates. The breakdown of some of the gate counts is as outlined in Table 2. When compared with a conventional architecture, the cost savings are significant. From the above illustration data of CP=2.5K and CW=4K for six application planes (P=6) and total of 15 windows per scan line (N=15), the estimated gate count are compared in Table 3. Consequently, the architecture of the present invention achieves a highly area efficient design, which can provide about a 78% circuit savings when compared to conventional graphics display system architectures.

FIG. 8 is a timing diagram illustrating examples of time slicing planes through a rendering data path of the present invention. The time controller in this example drives a standard definition video clock 800 running at 13.5 MHz and a high definition video clock with a clock 810 of 81 MHz. The time controller sequences the pixels of each applications plane (e.g., P1-P6) through a programmable slice allocation 820 to sequentially time slice the pixels through the data path input 830. In this timing diagram the output 850 of the data path is subject to two pipeline delay prior to blending the slotted planes by the time sliced blender output 860.

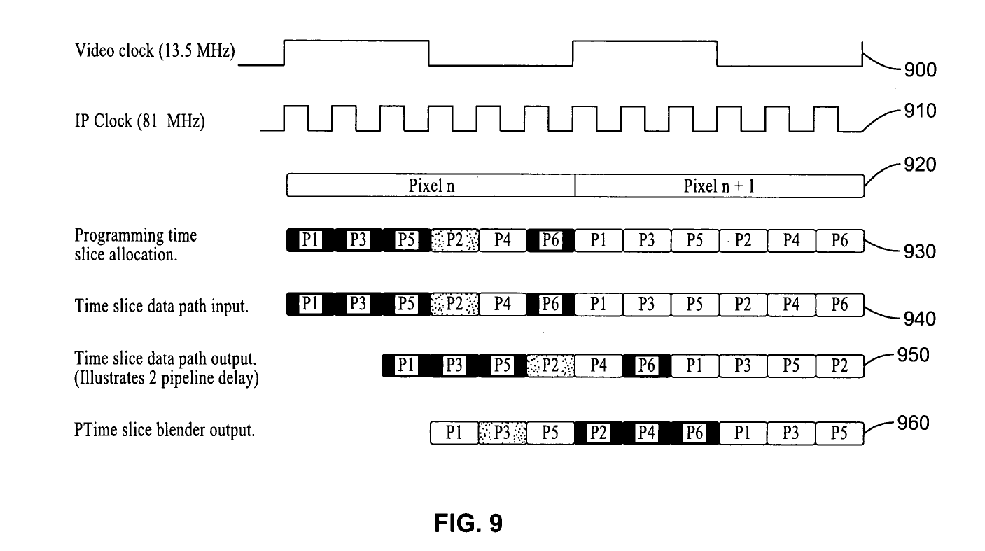

FIG. 9 is a timing diagram illustration of a programmable time slicing rendering of the applications plane, wherein the planes are reordered during programmable time slice allocation 930 and routed through data path input 940 for blending by time slice blender 960. The programmable plane reordering also presents a two pipeline delay during the routing of data to time slice data path output 950 and timeslice blended through blender output 960. The reordering of planes for blending is an important aspect of the present invention. If the timing controller determines the timing slots for different planes based on the blending order, plane reordering is achieved at a substantially reduced cost. In one embodiment of the present invention, the plane reorder is programmable to enable the timing controller to time slice the planes (e.g., 940) in a particular given order.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Design Parameters For Example Integration

| | | |
|---|---|---|
| Number of Planes | P | 6 |
| Number of overlapping Windows per plane | M | 4 |
| Number of DFEs deployed | N | 15 |

TABLE 2
Gate Costing for Design for Design of Table 1

| Standard Definition (SD) block | Cost in Gates | |
|---|---|---|
| Blender | 5.0 | K |
| Rendering data path | 25.0 | K |
| Switching fabric | 2.8 | K |
| Each DFE | 4.0 | |
| Miscellaneous | 5.4 | K |

TABLE 3
Comparison of Gate Costing

| Architecture | Gate Count | Savings |
|---|---|---|
| Conventional (no sharing of resources) | 460 K | -NA- |
| Shared DFEs, no time slicing of data path | 235 K | 49% |
| Time Sliced data path | 102 K | 78% |

1. An apparatus for rendering multiple graphics windows, comprising:
a plurality of application planes configured for maintaining application windows; and
means for rendering the output of said application planes to said application windows utilizing graphic rendering data paths being shared for a given application plane.

2. An apparatus as recited in claim 1, wherein said means for rendering comprises:
a graphics display engine coupled to said application planes; and
means for sharing rendering data paths for a given application plane.

3. An apparatus as recited in claim 2, wherein said graphics display engine comprises:
a window engine configured for generating an application window;
a direct memory access fetch engine coupled to said window engine, and configured for rendering a graphic image of said application window; and
a data path coupled between said direct memory access fetch engine to an application plane upon which said graphic image of said application window is to be rendered.

4. An apparatus as recited in claim 3, further comprising memory to which said plurality of application planes is coupled, said memory configured for retaining graphics data including pixel data for being fetched by said direct memory access fetch engines.

5. An apparatus as recited in claim 4, wherein each of said plurality of direct memory access fetch engines is assigned a unique identifier to operate on a particular window in a corresponding plane in said plurality of application planes.

6. An apparatus as recited in claim 5, wherein said plurality of direct memory access fetch engines are configured to each generate encoded pixel commands in response to matching a window plane number with an active plane number.

7. An apparatus as recited in claim 2:
wherein said means for sharing said rendering data paths is configured for sharing said rendering data paths between multiple direct memory access fetch engines which are coupled to said window engines;
wherein a separate rendering data path is not coupled to each direct memory access fetch engine;
wherein said sharing of said rendering data paths between said multiple direct memory access fetch engines is configured to reduce the amount of circuitry necessary to fabricate said rendering data paths.

8. An apparatus as recited in claim 1, further comprising means for time division multiplexing of said rendering data path between a plurality of application planes.

9. An apparatus as recited in claim 8, wherein said time division multiplexing means comprises a switching fabric for selecting and transporting one of a plurality of pixel commands in a time sliced manner within a rendering cycle to said rendering data path for said plurality of application planes.

10. An apparatus as recited in claim 9, further comprising a timing controller for performing said time division multiplexing by sequencing pixels of each of said plurality of application planes through a given said rendering data path in a time sliced manner.

11. An apparatus as recited in claim 10, wherein said timing controller determines timing slots for different application planes in the plurality of application planes in a blending order to reduce the cost of achieving plane reordering in the rendering data path.

12. An apparatus as recited in claim 9, wherein said switching fabric comprises a plurality of time division (data) multiplexers.

13. An apparatus as recited in claim 12, wherein said switching fabric further comprises a priority resolver for setting a window display priority for overlapping windows in the plurality of windows rendered to a the same plane.

14. An apparatus as recited in claim 1, further comprising a display blender configured for blending the plurality of applications planes received through said rendering data paths into a single plane to be displayed by a display device.

15. An apparatus as recited in claim 14, wherein said display blender comprises a multiply accumulate blender.

16. An apparatus as recited in claim 15:
wherein said display blender is configured for executing a multiply accumulate scheme for blending the plurality of application planes into a single displayed plane in a display device;
wherein said multiply accumulate scheme reduces the number of component circuitry required to fabricate the rendering data path in a graphics circuit chip.

17. An apparatus as recited in claim 1:
wherein said application windows can be overlapping or non-overlapping.
wherein said application windows are configured to receive various data formats;
wherein said data formats comprise indexed data formats;
wherein said data formats may be selected from the group of indexed data formats consisting essential of: 16 bit, 24 bit, 32 bit, RBG, and YCbCr.

18. An integrated graphics display chip, comprising:
a plurality of applications planes;
a memory configured for retaining graphics data including pixel data;
a plurality of window engines for rendering a plurality of graphics windows;
a plurality of direct memory access fetch engines coupled to the plurality of window engines, and configured for fetching windows information from said memory;
a rendering data path coupled to said plurality of direct memory access fetch engines and configured for outputting pixel data corresponding to the plurality of graphics windows to each of the plurality of application planes; and
a display blender for blending the plurality of applications planes into a single plane to be displayed by a display device at any given time.

19. An integrated display chip as recited in claim 18, further comprising a timing controller for sequencing pixels of each of said plurality of applications planes through said rendering data path in a time sliced manner.

20. An integrated display chip as recited in claim 19, wherein the timing controller determines the timing slots for different planes routed through the rendering data path based on a blender reordering scheme for the plurality of applications planes.

21. An integrated display chip as recited in claim 20, wherein said time sliced manner of sequencing pixels comprises sequentially time slotting said pixel data from said plurality of direct memory access fetch engines through said rendering data path to a displayed application plane of said display blender.

22. An integrated display chip as recited in claim 18, wherein the display blender is a multiply accumulate blender.

23. An integrated display chip as recited in claim 22, wherein a multiply accumulate scheme is implemented to blend the plurality of applications planes into a single displayed plane in a display device.

24. An integrated display chip as recited in claim 18, wherein each of said plurality of direct memory access fetch engines is assigned a unique identifier to operate on a particular window in a corresponding plane in the plurality of applications planes.

25. An integrated display chip as recited in claim 18, wherein said plurality of direct memory access fetch engines are configured for generating encoded pixel commands in response to matching an active plane number.

26. An integrated display chip as recited in claim 18, further comprising a switching fabric configured for selecting and transporting one of a plurality of pixel commands for the plurality of applications planes in a time sliced manner per a rendering cycle to the rendering data path.

27. An integrated display chip as recited in claim 26, wherein said switching fabric comprises a plurality of time division (data) multiplexers.

28. An integrated display chip as recited in claim 27, wherein said switching fabric further comprises a priority resolver for setting a window display priority for overlapping windows in the plurality of windows rendered to given plane to be displayed.

29. An integrated display chip as recited in claim 18, further comprising a control direct memory access fetch engine for retrieving window header information from the memory based on a unique identifier assigned to each of said plurality of direct memory access fetch engines.

30. An integrated display chip as recited in claim 18, wherein said direct memory access fetch engines encode the windows information retrieved from the memory into a plurality of pixel commands.

31. A method of rendering a plurality of application windows, comprising:
rendering application windows across multiple planes as pixel data retrieved in a windows formation fetch operation from memory;
sharing a rendering data pathway for processing pixel data rendered across different application windows; and
blending said pixel data received from multiple planes from said rendering data path for output to a display.

32. A method as recited in claim 31, wherein said data pathway is configured for processing pixel data rendered across different application windows for a given plane.

33. A method as recited in claim 32, further comprising performing time division multiplexing of said data pathway to time slice the use of said data pathway to increase throughput of pixel data.

34. A method as recited in claim 33, wherein said time division multiplexing comprises interconnecting a switch fabric to couple said pixel data from said windows formation fetch operations into said data path.

35. A method as recited in claim 34, further comprising prioritizing display order of overlapping windows rendered from said windows formation fetch operation to the same plane in the plurality of application planes.
